(19) United States
(12) Patent Application Publication
(10) Pub. No.: US 2023/0210151 A1
(43) Pub. Date: Jul. 6, 2023

(54) GRANULATED PRODUCT AND METHOD FOR PRODUCING SAME

(71) Applicant: TOYO SHINYAKU CO., LTD., Fukuoka-shi (JP)

(72) Inventors: Hiroya TAKAHASHI, Saga (JP); Yoshifumi KOSEKI, Saga (JP)

(73) Assignee: TOYO SHINYAKU CO., LTD., Fukuoka-shi (JP)

(21) Appl. No.: 18/181,205

(22) Filed: Mar. 9, 2023

Related U.S. Application Data
(63) Continuation of application No. PCT/JP2022/027092, filed on Jul. 8, 2022.

(30) Foreign Application Priority Data
Jul. 12, 2021 (JP) 2021-115226
Apr. 8, 2022 (JP) 2022-064382

(51) Int. Cl. A23L 19/00; A23L 5/30

(52) U.S. Cl. CPC A23L 19/01; A23L 5/30

(57) ABSTRACT

An object of the present invention is to provide a granulated product containing a dry powder of green leaves of at least one kind selected from grains, kale, sweet potatoes, mulberry trees, ashitaba, mugwort, Peucedanum japonicum, and kuma bamboo grass, and being excellent in dispersibility and smoothness, and to provide a method for producing the granulated product. The present invention allows for providing a granulated product excellent in dispersibility and smoothness and a method for producing the granulated product by producing a granulated product using a dry powder of green leaves of at least one kind selected from grains, kale, sweet potatoes, mulberry trees, ashitaba, mugwort, Peucedanum japonicum, and kuma bamboo grass, and controlling a specific gravity of the granulated product to a certain range.

### CROSS REFERENCE TO RELATED APPLICATIONS

This application is a Continuation application of International Application No. PCT/JP2022/027092, filed on Jul. 8, 2022, and which claims the benefit of priority to Japanese Application No. 2021-115226, filed on Jul. 12, 2021, and priority to Japanese Application No. 2022-064382, filed on Apr. 8, 2022. The content of each of these applications is hereby incorporated by reference in its entirety.

### TECHNICAL FIELD

The present invention relates to a granulated product containing a dry powder of green leaves of at least one kind selected from grains, kale, sweet potatoes, mulberry trees, ashitaba, mugwort, Peucedanum japonicum, and kuma bamboo grass, and a method for producing the granulated product.

### BACKGROUND ART

The green leaves of grains, kale, sweet potatoes, mulberry trees, ashitaba, mugwort, Peucedanum japonicum, and kuma bamboo grass (hereinafter, these plants are abbreviated as “aojiru materials”) contain abundant nutritional components such as vitamins, minerals, and dietary fibers, and are used as a raw material of so-called aojiru. It is known that these green leaves have various biological activities, and for example, Patent Literature 1 states that an extract of mugwort has an anti-obesity effect.

For the green leaves of the plants, those processed into a powder or squeezed juice are generally used as aojiru. The mostly common form of the aojiru is a processed food (powder beverages) to be used for drinking by being mixed with a liquid such as water, hot water, milk, or soymilk, and the form of powder beverages is widely distributed. When the aojiru is in the form of a powder beverage, a consumer disperses the powder beverage in a liquid such as water during ingestion by himself or herself. In order to facilitate ingestion by consumers, there is a demand for development of aojiru that is excellent in dispersibility (for example, easily dispersed in a liquid) and is smooth (has a less feeling of irritation).

### CITATION LIST

### Patent Literature

Patent Literature 1: JPS61-040763A

### SUMMARY OF INVENTION

### Technical Problem

As described above, there is a demand for development of aojiru excellent in dispersibility and smoothness. However, the aojiru developed so far is not necessarily sufficiently excellent in dispersibility and smoothness. Accordingly, the present invention has been made in view of the above problems, and an object of the present invention is to provide a granulated product containing a dry powder of green leaves of at least one kind selected from grains, kale, sweet potatoes, mulberry trees, ashitaba, mugwort, Peucedanum japonicum, and kuma bamboo grass, and being excellent in dispersibility and smoothness, and to provide a method for producing the granulated product.

### Solution to Problem

The present inventors have found that in a process of developing an oral composition containing a dry powder of green leaves of at least one kind selected from grains, kale, sweet potatoes, mulberry trees, ashitaba, mugwort, Peucedanum japonicum, and kuma bamboo grass, a granulated product having excellent dispersibility and smoothness can be obtained by producing a granulated product using the dry powder of the green leaves and controlling the specific gravity of the granulated product to a certain range, and have completed the present invention.

In addition, the present inventors have found that a granulated product excellent in dispersibility and smoothness can be obtained by controlling the specific gravity of the granulated product to a certain range and controlling the particle size distribution to a certain range, and have completed the present invention.

That is, the present invention is as follows.

<1> A granulated product containing a dry powder of green leaves of at least one kind selected from grains, kale, sweet potatoes, mulberry trees, ashitaba, mugwort, Peucedanum japonicum, and kuma bamboo grass, in which the granulated product has a specific gravity of less than 0.300 g/cm³.
<2> The granulated product according to <1>, in which the green leaves are green leaves of grains.
<3> The granulated product according to <2>, in which the grains are barley.
<4> The granulated product according to <1>, in which a content of the dry powder of the green leaves in the granulated product is the largest.
<5> The granulated product according to <1>, in which a content of the dry powder of the green leaves in the granulated product is 50 wt % or more.
<6> The granulated product according to <1>, in which a particle size distribution with a particle diameter of 500 μm or more is 10% or less in the granulated product.
<7> The granulated product according to <1>, in which a particle size distribution with a particle diameter of 300 μm or less is 30% or more in the granulated product.
<8> The granulated product according to <1>, which is an oral composition.
<9> The granulated product according to <1>, which is a food or drink composition.
<10> A method for producing a granulated product containing a dry powder of green leaves of at least one kind selected from grains, kale, sweet potatoes, mulberry trees, ashitaba, mugwort, Peucedanum japonicum, and kuma bamboo grass, the method including:

obtaining a granulated product by charging a raw material containing the dry powder of the green leaves into a fluidized bed granulator, fluidizing the raw material by supplying air, spraying water, and then drying the resultant product,

in which the granulated product has a specific gravity of less than 0.300 g/cm³.

<11> The method for producing a granulated product according to <10>, in which a particle size distribution with a particle diameter of 500 μm or more is 10% or less in the granulated product.
<12> The method for producing a granulated product according to <10>, in which a particle size distribution with a particle diameter of 300 μm or less is 30% or more in the granulated product.
<13> The method according to <10>, in which an amount of the water to be sprayed is 30 wt % or more relative to a total weight of the raw material.
<14> The method according to <10>, in which the drying is performed by supplying air of 90° C. or higher.
<15> The method according to <10>, in which the raw material is fluidized by supplying air of 50° C. to 75° C.
<16> The method according to <10>, in which the spraying is intermittent spray.

### Advantageous Effects of Invention

The present invention allows for a granulated product excellent in dispersibility and smoothness by producing a granulated product using a dry powder of green leaves of at least one kind selected from grains, kale, sweet potatoes, mulberry trees, ashitaba, mugwort, Peucedanum japonicum, and kuma bamboo grass, and controlling a specific gravity of the granulated product to a certain range.

### DESCRIPTION OF EMBODIMENTS

Hereinafter, the present invention will be described in detail.

1. Green Leaves of Aojiru Material

The aojiru material in the present invention means at least one kind of plant selected from grains, kale, sweet potatoes, mulberry trees, ashitaba, mugwort, Peucedanum japonicum, and kuma bamboo grass. Only one kind may be used, or two or more kinds may be used.

The green leaves of the aojiru material in the present invention mean a plant body including a leaf portion of the aojiru material, and may include a stem and other portions together with the leaves. In harvesting, it takes labor to remove the stems from the ground part to select only the leaf portion, and the stem portion also contains a large amount of nutritional components such as insoluble dietary fibers. Therefore, it is preferable to contain stems together with leaves from the viewpoint of manufacturing cost reduction and nutritional properties.

<Grains>

The term “grains” in the present invention refers to a generic term for plants of the family Poaceae having similar appearances, such as barley, wheat, rye, and oats. The grains in the present invention are particularly preferably barley.

The barley (Hordeum vulgare L.) is a plant native to Central Asia and is an annual plant or perennial plant belonging to the family Poaceae. The variety of barley used in the present invention is not limited. Any variety of barley may be used, and wild species or crossing species may be used. Examples of the barley include two-row barley, six-row barley, and bare barley, and these can be used alone or in combination of two or more kinds.

The green leaves in the barley may be those harvested at any harvesting time and are not limited. For example, when the grains are barley, it is preferable to use those (young barley leaves) harvested before the maturation period, that is, in the period from the tillering starting stage to the beginning of the ear emergence stage. Specifically, for example, young barley leaves harvested from barley having a height of 10 cm or more, preferably about 10 cm to 90 cm, particularly preferably about 20 cm to 80 cm, and particularly preferably about 30 cm to 70 cm are preferably used.

<Kale>

The term “kale” in the present invention means a plant belonging to the genus Brassica of the family Brassica and having a scientific name of Brassica oleracea var. acephala. The variety of kale is not limited, and various kinds of kale such as kitchen kale, tree kale, bush kale, marrow kale, collard, and kale can be used. The green leaves of kale may be those harvested at any harvesting time and are not limited.

<Sweet Potatoes>

The term “sweet potatoes” in the present invention means a plant belonging to the genus Ipomoea of the family Convolvulaceae and having a scientific name of Ipomoea batatas. The sweet potato is not limited as long as it is generally called yam. The variety of the sweet potato is not limited, but examples thereof include variety such as Suiou, Joy White, Kogane Sengan, Shiroyutaka, Satsumastarch, and Ayamurasaki. Among these, Suiou, which contains polyphenol in a high content, is preferred. The green leaves of sweet potatoes may be those harvested at any harvesting time, and are not limited. However, the green leaves of sweet potatoes are prefeven more preferably young stems and leaves in a state of retaining yellowish greenerably tip portions of stems and leaves (young stems and leaves), and.

<Mulberry Trees>

The term “mulberry trees” in the present invention means a plant of the genus Moms of the family Moraceae. The kind of mulberry trees is not limited, but examples thereof include white mulberry trees, Korean mulberry trees, Indian mulberry trees, long mulberry trees, Morus tiliaefolia, Morus boninensis, and Himalayan mulberry trees. The green leaves of the mulberry trees may be those harvested at any harvesting time and are not limited.

<Ashitaba>

The term “ashitaba” in the present invention means a plant belonging to the genus Angelica of the family Apiaceae and having a scientific name of Angelica keiskei. The variety of Ashitaba is not limited, and can be appropriately used. The green leaves of Ashitaba may be those harvested at any harvesting time and are not limited.

<Mugwort>

The term “mugwort” in the present invention means a perennial of the genus Artemisia of the family Asteraceae. The kind of mugwort is not limited, but examples thereof include mugwort, wormwood, Tarragon, Nitrofu mugwort, Artemisia congesta, fragrant wormwood, Artemisia japonica, redstem wormwood, Artemisia apiacea, sweet annie, Artemisia keiskeana, Artemisia pedunculosa, Artemisia furcata var. pedunculosa, Artemisia arctica var. sachalinensis, Artemisia sinanensis, Artemisia glomerata, Artemisia tanacetifolia, hoary mugwort, Artemisia sacrorum, Artemisia lancea, Artemisia gilvescens, Artemisia codonocephala, Artemisia monophylla, Artemisia unalaskensis, Artemisia koidzumii, Artemisia stolonifera, Artemisia momiyamae, Artemisia rubripes, Artemisia montana, Artemisia indica, Artemisia schmidtiana, and Artemisia kitadakensis. Among them, mugwort is particularly preferred. The green leaves of mugwort may be those harvested at any harvesting time and are not limited.

<Peucedanum japonicum>

The term “Peucedanum japonicum” in the present invention means a plant belonging to the genus Peucedanum of the family Apiaceae and having a scientific name of Peucedanum Japonicum. The Peucedanum japonicum is referred to as Botanboufu, Chomeiso, Chomeigusa, Chomyfusa, Bofu, Sacna, Upvarsafuna, Chomygusa, and Botanboufu depending on the region. The kind of the Peucedanum japonicum is not limited, and may be appropriately used. The green leaves of the Peucedanum japonicum may be those harvested at any harvesting time, and are not limited.

<Kuma Bamboo Grass>

The term “kuma bamboo grass” in the present invention means a plant belonging to the genus Sasa of the family Poaceae. The kind of the kuma bamboo grass is not limited, but examples thereof include Sasa veitchii, Sasa kurilensis, Sasamorpha borealis, Sasa senanensis, Sasa palmata, and Sasa niponica. The green leaves of the kuma bamboo grass may be those harvested at any harvesting time, and are not limited.

2. Dry Powder of Green Leaves

The dry powder of green leaves in the present invention means a powder obtained by processing green leaves of at least one kind selected from grains, kale, sweet potatoes, mulberry trees, ashitaba, mugwort, Peucedanum japonicum, and kuma bamboo grass into a dry powder. Examples of the dry powder of green leaves include, but are not limited to, a powder obtained by pulverizing green leaves and drying and powdering the pulverized green leaves (pulverized powder of green leaves), a powder obtained by drying and powdering squeezed juice of green leaves (powder of squeezed juice of green leaves), and a powder obtained by drying and powdering an extract of green leaves (powder of an extract of green leaves). The dry powder of green leaves according to the present invention is preferably a pulverized powder of green leaves from the viewpoint of excellent dispersibility and smoothness, from the viewpoint of ease of processing, storage, transportation, and the like, and from the viewpoint of rich dietary fibers.

As the pulverized powder of green leaves in the present invention, for example, a powder obtained by combining a drying treatment and a pulverization treatment can be used. The drying treatment and the pulverization treatment may be performed at the same time, or either one may be performed first, and the pulverization treatment is preferably performed after the drying treatment is performed first. If necessary, one or more treatments selected from treatments such as a blanching treatment and a sterilization treatment may be performed in combination. In addition, the number of times of performing the pulverization treatment is not limited, and the pulverization treatment may be performed once or more, for example, performing a fine pulverization treatment of pulverizing more finely after performing a coarse pulverization treatment.

The blanching treatment is a treatment for keeping the green color of the green leaves of the aojiru material, and examples of the method of the blanching treatment include a hot water treatment and a steaming treatment.

Examples of the hot water treatment include a method in which the green leaves of the aojiru material are treated in hot water or water vapor of preferably 70° C. to 100° C. and more preferably 80° C. to 100° C. for preferably 60 seconds to 240 seconds and more preferably 90 seconds to 180 seconds.

As the steaming treatment, an intermittent steaming treatment in which a treatment of steaming the green leaves of the aojiru material with water vapor and a cooling treatment are repeated under normal pressure or pressure is preferred. In the intermittent steaming treatment, the steaming treatment with water vapor is performed, for example, preferably for 20 seconds to 40 seconds, and more preferably for 30 seconds. The cooling treatment after the steaming treatment is preferably performed immediately, and the method of the cooling treatment is not limited. However, immersion in cold water, refrigeration, cooling by cold air, vaporization cooling by hot air, vaporization cooling in combination of hot air and cold air, and the like are used. Among them, the vaporization cooling in combination of hot air and cold air is preferred. Such a cooling treatment is performed such that the temperature of the green leaves of the aojiru material is preferably 60° C. or lower, more preferably 50° C. or lower, and still more preferably 40° C. or lower. In addition, in order to produce a pulverized powder of green leaves of the aojiru material rich in nutritional components such as vitamins, minerals, and chlorophyll, it is preferable to repeat the intermittent steaming treatment 2 times to 5 times.

The sterilization treatment is not limited as long as it is a sterilization treatment generally known to those skilled in the art, but can be a treatment of physically or chemically killing microorganisms using a temperature, a pressure, an electromagnetic wave, a drug, or the like.

When the blanching treatment is performed in addition to the drying treatment and the pulverization treatment, the blanching treatment is preferably performed before the drying treatment. When the sterilization treatment is performed in addition to the drying treatment and the pulverization treatment, the sterilization treatment is preferably performed after the drying treatment or before or after the pulverization treatment.

The drying treatment is not limited, but examples thereof include a treatment in which the green leaves of the aojiru material are dried so that the water content of the green leaves is 10 wt % or less, and preferably 5 wt % or less. The drying treatment may be performed by any method known to those skilled in the art, such as hot air drying, high-pressure vapor drying, electromagnetic wave drying, or freeze drying. The drying by heating may be performed, for example, by heating at preferably 40° C. to 140° C. and more preferably 80° C. to 130° C. The drying may be performed at a temperature and for a time such that the green leaves of the aojiru material are not discolored.

The pulverization treatment is not limited, but examples thereof include a treatment of pulverizing a plant body by any method generally used by those skilled in the art. In the pulverization treatment, coarse pulverization and fine pulverization in combination are preferably performed, from the viewpoint of increasing pulverization efficiencies, such as uniformization of particle size and shortening of pulverization time.

In the pulverization treatment, in the coarse pulverization step, the green leaves are crushed using any equipment or instrument for coarse pulverization generally used by those skilled in the art, such as a cutter, a slicer, and a dicer, so that the long diameter of the green leaves is adjusted to, for example, about 20 mm or less, and preferably about 0.1 mm to 10 mm. In the fine pulverization step, for example, green leaves of the aojiru material are finely pulverized using any equipment or instrument for a fine powder that is generally used by those skilled in the art, such as a crusher, a mill, a blender, and a stone mill. The physical properties such as a specific gravity and particle size distribution of the green leaves of the aojiru material can be adjusted by appropriately setting conditions of the pulverization treatment based on a method generally used by those skilled in the art.

As the powder of squeezed juice of green leaves in the present invention, for example, a powder obtained by concentrating the squeezed juice of green leaves at a low temperature to concentrate the solid content, and freeze-drying or spray-drying the concentrated liquid can be used.

The particle diameter of the dry powder of the green leaves used as the raw material of the granulated product in the present invention is not limited, and a raw material having a particle diameter that allows easy granulation may be appropriately selected and used. The particle diameter of the dry powder of the green leaves may be, for example, a median diameter of 60 μm or less, 50 μm or less, 40 μm or less, 30 μm or less, or 25 μm or less.

The median diameter of the dry powder of green leaves is also referred to as D₅₀ or d50, and refers to a diameter at which the amount of particles having a large particle diameter and the amount of particles having a small particle diameter are equal to each other when the powder is divided into two parts based on the particle diameter. The median diameter can be measured using, for example, a laser diffraction/scattering method. Specifically, the median diameter is, for example, a particle diameter with a cumulative of 50% (×50) in a particle size distribution measured using LMS-300 or LMS-350 manufactured by Seishin Enterprise Co., Ltd., which is a laser diffraction/scattering type particle size distribution measuring apparatus.

3. Granulated Product Containing Dry Powder of Green Leaves

<Granulated Product>

The granulation means an operation of aggregating a plurality of particles to form an aggregate. In the aggregate (granulated product), voids are formed between the particles when the particles are aggregated, and there is a structural difference between the granulated product and the raw material particles used for granulation. The granulated product containing the dry powder of green leaves of the aojiru material is obtained by granulating the dry powder of green leaves of the aojiru material as a raw material, and has a specific gravity of less than 0.300 g/cm³.

The granulated product may further contain a raw material other than the dry powder of green leaves of the aojiru material, such as an excipient or a sweetener. By controlling the specific gravity of the granulated product so as to fall within the above range, a granulated product excellent in dispersibility and smoothness can be obtained. The granulated product according to the present invention may be an aggregate obtained by aggregating a plurality of particles by any method, and the size of the granulated product is not limited.

The granulation method in the present invention may be appropriately selected from granulation methods generally used by those skilled in the art, and is not limited. Examples thereof include a fluidized bed granulation, an extrusion granulation, a rolling granulation, and a stirring granulation. In any of the granulation methods, a granulated product satisfying the specific gravity condition defined in the present invention can be produced by using any granulation apparatus available in the market and by appropriately setting various production conditions such as a drying temperature. After the granulation step is performed, pulverization or classification may be performed to adjust the specific gravity or the particle size distribution of the granulated product.

As described above, the granulated product of the present invention can be obtained by any of the granulation methods, and from the viewpoint of easiness of granulation, fluidized bed granulation is particularly preferable. The fluidized bed granulation refers to a method for forming a granulated product which is an aggregate of powder particles by spraying a binding liquid such as water to powder particles as a raw material while applying air to the powder particles and fluidizing the powder particles by an air flow to bind the powder particles to each other.

In the case of fluidized bed granulation, the granulated product according to the present invention can be obtained by a production method including a step of obtaining a granulated product by charging a dry powder of green leaves of a aojiru material as a raw material into a fluidized bed granulator, spraying water to the raw material fluidized by supplying air, and then drying the raw material. As the fluidized bed granulator used for granulation, any commercially available granulator can be used. By appropriately setting various production conditions of the granulation apparatus in accordance with the characteristics of the raw materials to be used, a granulated product satisfying the conditions of the present invention can be produced. If necessary, the specific gravity and the particle diameter of the granulated product may be adjusted by classifying or pulverizing the obtained granulated product.

The temperature of the air supplied at the time of fluidizing the raw material is not limited, and may be appropriately adjusted in accordance with the characteristics of the raw material to be used. In the fluidized bed granulation, water is sprayed to the powder particles fluidized by supplying air, and the powder particles are wetted, so that the powder particles are bound to each other. Thus, the wettability of the powder particles affects the degree of granulation. However, the wettability of the powder particles varies depending on the raw material to be used and the temperature of the air to be supplied, and thus, the temperature of the air to be supplied may be appropriately adjusted in accordance with the characteristics of the raw material to be used. When the temperature of the air to be supplied is low, the amount of water to be evaporated is small, and the powder particles are easy to wet. In contrast, when the temperature of the air to be supplied is high, the amount of water to be evaporated is large, and the powder particles are difficult to wet.

In the case of granulating green leaves of a aojiru material, the temperature of air supplied at the time of fluidizing the raw material is preferably 50° C. to 75° C., more preferably 50° C. to 70° C., and particularly preferably 50° C. to 60° C., from the viewpoint of easily obtaining a granulated product that falls within the specific gravity range in the present invention and is particularly excellent in dispersibility and smoothness. The temperature of air to be supplied can be set in the fluidized bed granulator, and thus, the temperature of the fluidized bed granulator may be set to 50° C., for example, when air of 50° C. is desired to be supplied.

In the fluidized bed granulation, the method for spraying water may be either continuous spraying or intermittent spraying. Continuous spraying refers to a spraying method in which spraying of water is continued without stopping at all from the start of spraying of water to the end of spraying of the entire amount of water. The intermittent spraying refers to a spraying method in which a period of time during which spraying of water is stopped at least once is provided from the start of spraying of water to the end of spraying of the entire amount of water. From the viewpoint of obtaining a granulated product particularly excellent in dispersibility and smoothness, spraying of water preferably proceeds while adjusting the water addition state by using the intermittent spraying method. In the present invention, spraying of water is not limited to spraying of only water, and is a concept including spraying of an aqueous solution in which a binder or the like is dissolved in water.

In the fluidized bed granulation, the amount of water to be sprayed is not limited and may be appropriately adjusted in accordance with the characteristics of the raw material to be used. From the viewpoint of easily obtaining a granulated product that falls within the specific gravity of the present invention and is particularly excellent in dispersibility and smoothness when the green leaves of the aojiru material according to the present invention are granulated, the amount of water to be sprayed is preferably 20 wt % or more, more preferably 30 wt % or more, still more preferably 40 wt % or more, particularly preferably 45 wt % or more, and most preferably 50 wt % or more relative to the total weight of the raw materials, as the lower limit of the amount of water to be sprayed. As the upper limit of the amount of water to be sprayed, the amount of water to be sprayed is preferably 300 wt % or less, more preferably 250 wt % or less, still more preferably 200 wt % or less, particularly preferably 150 wt % or less, and most preferably 100 wt % or less, relative to the total weight of the raw materials, from the viewpoint of shortening the drying time and improving productivity. When the granulated product contains a raw material other than the dry powder of the green leaves of the aojiru material, the amount of water to be sprayed is an amount relative to the total weight including the weight of the dry powder of the green leaves of the aojiru material and the raw material other than the dry powder of the green leaves of the aojiru material.

In the fluidized bed granulation, the granulation step may be performed only once, or may be performed a plurality of times. Regarding the granulated product according to the present invention, a granulated product excellent in dispersibility and smoothness can be obtained even when the granulation step is performed once or a plurality of times. The granulation step is more preferably performed once from the viewpoint of productivity and the like.

The fluidized bed granulation includes a step (drying step) of obtaining a granulated product by drying after the step of spraying water to the fluidized raw material. The temperature of the air supplied during drying is not limited and may be appropriately adjusted in accordance with the characteristics of the raw material to be used. However, the temperature of the air is preferably 80° C. or higher, more preferably 90° C. or higher, still more preferably 100° C. or higher, and particularly preferably 110° C. or higher, from the viewpoint of easily obtaining a granulated product that falls within the specific gravity of the present invention when the green leaves of the aojiru material according to the present invention are granulated and from the viewpoint of shortening the drying time. The temperature of air to be supplied can be set in the fluidized bed granulator, and thus the temperature of the fluidized bed granulator may be set to 90° C., for example, when air of 90° C. is desired to be supplied. The water content of the obtained granulated product is not limited, but is preferably 10 wt % or less, more preferably 8 wt % or less, still more preferably 7 wt % or less, particularly preferably 6 wt % or less, and most preferably 5 wt % or less.

In the granulated product according to the present invention, additives such as a binder, an excipient, and a thickener may be appropriately added as necessary in addition to the dry powder of green leaves of the aojiru material. The kind of the additives is not limited, but examples thereof include saccharides such as glucose, maltitol, and erythritol, thickening polysaccharides such as guar gum, starch such as corn starch, and starch degradation products such as dextrin and indigestible dextrin. Only one kind of the additives may be added, or two or more kinds thereof may be added.

To the granulated product according to the present invention, a dry powder of green leaves of a plant which is not a aojiru material may be appropriately added. Examples of the green leaves of plants which are not aojiru materials include green tea, spinach leaves, turnip leaves, and komatsuna leaves. The content of the dry powder of green leaves of the plant which is not a aojiru material is not limited, but from the viewpoint of dispersibility, smoothness, or nutrition, the content (total weight) of the dry powder of green leaves of the aojiru material is preferably larger than that of the dry powder of green leaves of a plant which is not a aojiru material.

The content of the dry powder of green leaves of the aojiru material in the granulated product according to the present invention is not limited. In the past, when a powder containing a high amount of dry powder of green leaves of a aojiru material (particularly, pulverized powder of green leaves) is granulated, the resultant granulated product has a poor dispersibility, and thus, basically, the powder is filled as it is without granulation and is commercially available as a aojiru. However, the present inventors have found that, by controlling the specific gravity of the granulated product to a predetermined range, a granulated product excellent in dispersibility and smoothness can be obtained even when a high amount of dry powder of green leaves of a aojiru material is contained. The granulated product containing the large content of the aojiru material has an advantage that the aojiru material can be ingested in a large amount, as compared with the granulated product containing the small content of the aojiru material, when the total amount of the granulated product orally ingested is the same. Thus, from the viewpoint of efficiently ingesting nutritional components, the content of the dry powder of green leaves of the aojiru material in the granulated product is preferably 50 wt % or more, more preferably 60 wt % or more, still more preferably 70 wt % or more, yet still more preferably 80 wt % or more, particularly preferably 95 wt % or more, and most preferably 100 wt %. Similarly, from the viewpoint of efficiently ingesting nutritional components, the content of the dry powder of green leaves of the aojiru materials is preferably the largest among the raw materials blended in the granulated product.

Among the dry powders of green leaves of the aojiru materials, the dry powder of green leaves of grains is particularly excellent in flavor and nutrition. Thus, the content of the dry powder of green leaves of grains is preferably the largest among the raw materials blended in the granulated product according to the present invention.

<Specific Gravity of Granulated Product>

The specific gravity of the granulated product in the present invention means a bulk density (loose bulk density) measured in a state where the granulated product is gently filled in a container, and can be measured using, for example, a powder property evaluation device (Powder Tester (R) PT-X; Hosokawa Micron Corporation). In the granulated product according to the present invention, controlling the specific gravity to be in the range of less than 0.300 g/cm³ allows for providing a granulated product excellent in dispersibility and smoothness. The specific gravity of the granulated product according to the present invention is not limited as long as it is in the range of less than 0.300 g/cm³, but as the upper limit of the specific gravity, the specific gravity is preferably 0.295 g/cm³ or less, more preferably 0.290 g/cm³ or less, still more preferably 0.285 g/cm³ or less, yet still more preferably 0.280 g/cm³ or less, particularly preferably 0.270 g/cm³ or less, more particularly preferably 0.260 g/cm³ or less, and most preferably 0.250 g/cm³ or less, from the viewpoint of further improving dispersibility. The lower limit of the specific gravity of the granulated product according to the present invention is not limited, but as the lower limit of the specific gravity, the specific gravity is preferably 0.100 g/cm³ or more, more preferably 0.130 g/cm³ or more, still more preferably 0.140 g/cm³ or more, particularly preferably 0.150 g/cm³ or more, and most preferably 0.160 g/cm³ or more, from the viewpoint of further improving dispersibility.

<Particle Size Distribution of Granulated Product>

The particle size distribution of the granulated product in the present invention means a particle size distribution on a weight basis, and can be measured using, for example, an electric sieve vibration machine (MICRO VIBRO SIFTER M-2; manufactured by Tsutsui Rikagakukiki Co., Ltd.). The particle size distribution of the granulated product according to the present invention is not limited, but from the viewpoint of dispersibility, powder flow, or smoothness, the particle size distribution with a particle diameter of 500 μm or more is preferably 40% or less, more preferably 30% or less, still more preferably 25% or less, yet still more preferably 20% or less, particularly preferably 15% or less, and most preferably 10% or less. From the viewpoint of dispersibility, powder flow, or smoothness, the particle size distribution with a particle diameter of 300 μm or more is preferably 50% or less, more preferably 40% or less, still more preferably 35% or less, particularly preferably 30% or less, and most preferably 25% or less.

From the viewpoint of dispersibility, ease of handling (powder flow), or smoothness, the particle size distribution with a particle diameter of 300 μm or less is preferably 20% or more, more preferably 30% or more, still more preferably 40% or more, yet still more preferably 50% or more, particularly preferably 60% or more, and most preferably 70% or more. From the viewpoint of dispersibility, ease of handling (powder flow), or smoothness, the particle size distribution with a particle diameter of 150 μm or less is preferably 15% or more, more preferably 30% or more, still more preferably 40% or more, particularly preferably 50% or more, and most preferably 60% or more. From the viewpoint of dispersibility, ease of handling (powder flow), or smoothness, the particle size distribution with a particle diameter of 106 μm or less is preferably 15% or more, more preferably 30% or more, still more preferably 40% or more, particularly preferably 50% or more, and most preferably 60% or more. In addition, from the viewpoint of dispersibility, ease of handling (powder flow), or smoothness, the particle size distribution with a particle diameter of 106 μm or more is preferably 3% or more, more preferably 5% or more, still more preferably 7% or more, particularly preferably 10% or more, and most preferably 15% or more.

<Oral Composition>

The granulated product according to the present invention can be used as an oral composition. The form of the oral composition is not limited, but examples thereof include foods or drinks, quasi drugs, and pharmaceuticals. A dry powder of green leaves of the aojiru material is often ingested as aojiru, so that the granulated product is preferably used as a food or drink composition. The form of the food or drink composition is not limited, but examples thereof include foods with function claims, foods for specified health uses, and health foods.

The granulated product according to the present invention is preferably used as a powder beverage as the granulated product is easily dispersed in a solvent such as water. The powder beverage means a processed food to be used for drinking by being mixed with a liquid such as water, hot water, milk, or soymilk. The powder beverage is advantageous in that it is light in weight and easy to carry.

### EXAMPLES

Hereinafter, the present invention will be described in more detail with reference to Examples, but the present invention is not limited to these Examples, and the present invention can take various forms as long as the problems of the present invention can be solved.

—Test 1—

### Production of Dry Powder of Green Leaves

As a raw material, ground portions (leaves and stems) of barley mowed with a height of about 30 cm were used. A pretreatment was performed in which the ground portions were washed with water, adhered mud and the like were removed, and the ground portions were cut to a size of about 5 cm to 10 cm. The pretreated young barley leaves were subjected to a blanching treatment only once with hot water of 90° C. to 100° C. for 90 seconds to 120 seconds, and then cooled with cold water. Subsequently, the obtained young barley leaves were dried in a dryer for 20 minutes to 180 minutes with hot air of 80° C. to 130° C. until the water content became 5 wt % or less. The dried young barley leaves were subjected to a coarse pulverization treatment to have a size of about 1 mm. The obtained young barley leaves were subjected to a fine pulverization treatment to produce a powder of young barley leaves having a median diameter of 20 μm.

Production of Granulated Product Containing Dry Powder of Green Leaves

As a dry powder of green leaves, the powder of young barley leaves produced by the above production method were used. A granulated product containing the dry powder of green leaves was produced by the method described below.

### Example 1

After a powder of young barley leaves was charged into a fluidized bed granulator, water of 75 wt % relative to a weight of the powder of young barley leaves was intermittently sprayed while the powder of young barley leaves was fluidized by supplying air of 55° C. Then, the powder of young barley leaves was dried by supplying air of 120° C., thereby obtaining a granulated product of Example 1 (water content: 5 wt % or less).

### Example 2

After a powder of young barley leaves was charged into a fluidized bed granulator, water of 50 wt % relative to a weight of the powder of young barley leaves was intermittently sprayed while the powder of young barley leaves was fluidized by supplying air of 55° C. Then the powder of young barley leaves was dried by supplying air of 120° C., thereby obtaining a granulated product of Example 2 (water content: 5 wt % or less).

### Comparative Example 1

A powder of young barley leaves was charged into an extrusion granulator, the powder of young barley leaves was granulated by appropriately adding water in an amount of 10 wt % to 30 wt % relative to the weight of the powder of young barley leaves while paying attention to clogging of a screen (using a 1 mm screen), and the powder of young barley leaves was dried by a shelf type dryer at a drying temperature of 90° C., thereby obtaining a granulated product of Comparative Example 1 (water content: 5 wt % or less).

### Comparative Example 2

An ungranulated powder of young barley leaves was used as Comparative Example 2.

Measurement of Specific Gravity and Particle Size Distribution

Specific gravities and particle size distributions of Examples and Comparative Examples were measured by the methods described below.

<Specific Gravity>

Using a powder characteristic evaluation device (powder tester (R) PT-X; manufactured by

Hosokawa Micron Corporation), a test substance was dropped from a predetermined height and placed in a stainless steel container of 100 cm³, and the specific gravity was measured by measuring the mass. The measurement results are shown in Table 1.

TABLE 1

| | | | Comparative | Comparative |
|---|---|---|---|---|
| | Example 1 | Example 2 | Example 1 | Example 2 |
| Specific gravity | 0.211 | 0.181 | 0.310 | 0.209 |
| (g/cm³) | | | | |

<Particle Size Distribution>

The particle size distribution was measured using an electric sieve vibration machine (MICRO VIBRO SIFTER M-2; manufactured by Tsutsui Rikagakukiki Co., Ltd.). The measurement results are shown in Table 2.

TABLE 2

| | | | | Compara- | Compara- |
|---|---|---|---|---|---|
| | | Exam- | Exam- | tive Exam- | tive Exam- |
| | | ple 1 | ple 2 | ple 1 | ple 2 |
| Particle size | 500 μm- | 8.4 | 4.8 | 88.8 | 0.4 |
| distribution | 300 μm-500 μm | 6.2 | 5.8 | 6.0 | 0.4 |
| (%) | 150 μm-300 μm | 7.0 | 7.2 | 4.0 | 0.0 |
| | 106 μm-150 μm | 3.0 | 4.6 | 1.0 | 1.0 |
| | -106 μm | 75.4 | 77.6 | 0.2 | 98.2 |

| | | | | |
|---|---|---|---|---|
| Total | 100.0 | 100.0 | 100.0 | 100.0 |

Evaluation of Dispersibility

The dispersibility of Examples and Comparative Examples was evaluated by the following methods (1) and (2).

(1) Evaluation of Affinity for Water

(1)-1. Dispersibility when Sample was Put into Water

To a cup (height: 100 mm, upper diameter: 75 mm, bottom diameter: 55 mm) containing 100 mL of water, each sample (3 g) was gently charged, followed by measuring, as the dispersion time, the time from a time point when the sample was dropped to a time point when the entire sample was immersed in water and dispersed in water (the time from a state where the sample was suspended on the liquid surface to a time point when the sample was sunk in water), and an affinity for water was evaluated in accordance with the following criteria. The results are shown in Table 3. The term “an affinity for water” refers to the wettability of the powder to water.

### <Reference>

A: The dispersion time was shorter than 60 seconds;
B: The dispersion time was 60 seconds or longer

TABLE 3

| | | | Comparative | Comparative |
|---|---|---|---|---|
| | Example 1 | Example 2 | Example 1 | Example 2 |
| Affinity for water | A | A | A | B |

As is clear from Table 3, it was revealed that the granulated products of Examples 1 and 2 had a shorter dispersion time than the ungranulated powder of young barley leaves (Comparative Example 2) and were quickly dispersed in water.

(1)-2. Dispersibility when Sample was Put into Water

To a cup (height: 100 mm, upper diameter: 75 mm, bottom diameter: 55 mm) containing each sample (3 g), 100 mL of water was gently poured. Thereafter, the water surface was observed, and the presence or absence of powder floating was evaluated in accordance with the following criteria. The results are shown in Table 4. The term “powder floating” refers to the ease of floating of powder on the water surface.

### <Reference>

Presence: At least a part of the sample is floating on the water surface
Absence: the sample is not floating on the water surface (dispersed or sunk in water)

TABLE 4

| | | | Comparative | Comparative |
|---|---|---|---|---|
| | Example 1 | Example 2 | Example 1 | Example 2 |
| Powder floating | Absence | Absence | Absence | Presence |

As is clear from Table 4, the ungranulated powder of young barley leaves (Comparative Example 2) showed powder floating, whereas the granulated products of Examples did not show powder floating.

(2) Evaluation of Dispersion Stability

To a cylindrical (diameter: 75 mm) transparent cup containing 100 mL of water, each sample (3 g) was charged, and the mixture was stirred 10 times (stirring speed: 1 time/sec to 1.5 times/sec) using a muddler. Each sample is insoluble, and the sample is temporarily dispersed in water by stirring. When time elapses, the sample gradually settles, and a clear portion (supernatant) is formed above. The mixture was allowed to stand for one minute after the stirring is completed, then the contents of the cup were observed, and the height of the supernatant (separation distance) was measured. And the dispersion stability was evaluated in accordance with the following criteria. A shorter separation distance means that the sample is more dispersed in water in a stable state and is less likely to be separated. The measurement results are shown in Table 5.

### <Reference>

A: The dispersion distance was less than 5 mm;
B: The dispersion distance was 5 mm or more.

TABLE 5

| | | | Comparative | Comparative |
|---|---|---|---|---|
| | Example 1 | Example 2 | Example 1 | Example 2 |
| Dispersion stability | A | A | B | A |

As is clear from Table 5, it was found that the granulated products of Examples 1 and 2 had good dispersion stability, whereas the granulated product of Comparative Example 1 had poor dispersion stability.

From the tests (1) and (2), it was found that the ungranulated powder of young barley leaves (Comparative Example 2) had a poor affinity for water, and the granulated product of Comparative Example 1 had poor dispersion stability. On the other hand, it was found that the granulated products of Examples 1 and 2 were excellent in both affinities for water and dispersion stability, and were excellent in dispersibility. Based on this result, the dispersibility was comprehensively evaluated according to the following criteria (Table 6).

<Comprehensive Evaluation of Dispersibility>

A: A case where an affinity for water was evaluated as “A”, presence or absence of powder floating was evaluated as “No”, and dispersion stability was evaluated as “A”

B: Cases other than the above

TABLE 6

| | | | Comparative | Comparative |
|---|---|---|---|---|
| | Example 1 | Example 2 | Example 1 | Example 2 |
| Comprehensive | A | A | B | B |
| evaluation of | | | | |
| dispersibility | | | | |

Evaluation of Smoothness (Feeling of Going Down a Throat)

To a cup containing 100 mL of water, each sample (3 g) was charged. After the charging, the mixture was stirred 10 times using a muddler (stirring speed: 1 time/sec to 1.5 times/sec). After that, each beverage was immediately ingested, and the feeling of going down a throat was evaluated in accordance with the following criteria. The results are shown in Table 7.

### <Reference>

A: No irritation or little irritation was felt on the throat during drinking;
B: irritation was felt on the throat during drinking

TABLE 7

| | | | Comparative | Comparative |
|---|---|---|---|---|
| | Example 1 | Example 2 | Example 1 | Example 2 |
| Feeling of | A | A | B | A |
| going down a throat | | | | |

As is clear from Table 7, the granulated products of Examples did not give a feeling of irritation during drinking and were smooth, whereas the granulated product of Comparative Example 1 gave a feeling of irritation during drinking and was difficult to drink.

Handleability

A package of an aluminum pouch was filled with each sample (3 g). Using the obtained package containing the sample, the scattering of the powder during package opening and the powder flow during charging into the cup (index of ease of handling) were evaluated in accordance with the criteria, and the handleability was checked. The results are shown in Table 8.

### <Reference>

### Scattering of Powder During Opening

The term “scattering of powder” means a degree that the powder is likely to be scattered in the air.
A: The amount of powder scattering is small during the package opening;
B: The amount of powder scattering is large during the package opening

### Powder Flow During Charging

The term “powder flow” refers to the ease of flowing of the powder.
A: The powder flow during charging into the cup is smooth;
B: The powder flow during charging into the cup is not smooth

TABLE 8

| | | | Comparative | Comparative |
|---|---|---|---|---|
| | Example 1 | Example 2 | Example 1 | Example 2 |
| Scattering of powder | A | A | A | B |
| during opening | | | | |
| Powder flow during | A | A | A | B |
| charging | | | | |

As is clear from Table 8, it was found that the granulated products of Examples were superior in handleability to the powder of young barley leaves.

Summary of Results

According to the test described above, the granulated products containing the powder of young barley leaves and having a specific gravity of less than 0.300 g/cm³ (Examples 1 and 2) were excellent in all of the dispersibility, feeling of going down a throat, and handleability. On the other hand, the granulated product containing the powder of young barley leaves and having a specific gravity of more than 0.300 g/cm³ (Comparative Example 1) was excellent in the handleability, but was poor in the dispersibility and feeling of going down a throat. In addition, the ungranulated powder of young barley leaves (Comparative Example 2) was excellent in feeling of going down a throat, but was poor in dispersibility and handleability. Therefore, it was revealed that a granulated product containing the powder of young barley leaves and having a specific gravity of less than 0.300 g/cm³ is excellent in the dispersibility, feeling of going down a throat, and handleability.

—Test 2—

### Production of Granulated Product Containing Dry Powder of Green Leaves

A granulated product containing a dry powder of green leaves of a aojiru material was produced by the method described below.

### Example 3

After a raw material prepared by mixing 80 wt % of the powder of young barley leaves produced in Test 1, 5 wt % of xylooligosaccharide, and 15 wt % of lactose was charged into a fluidized bed granulator, water of 50 wt % relative to the total weight of the raw material was intermittently sprayed while the raw material was fluidized by supplying air of 70° C. Then, the raw material was dried by supplying air of 100° C., thereby obtaining a granulated product of Example 3 (water content: 5 wt % or less).

### Comparative Example 3

After a raw material prepared by mixing 80 wt % of the powder of young barley leaves produced in Test 1, 5 wt % of xylooligosaccharide, and 15 wt % of lactose was charged into a fluidized bed granulator, water of 10 wt % relative to a total weight of the raw material was intermittently sprayed while the raw material was fluidized by supplying air of 80° C. Then, the raw material was dried by supplying air of 80° C., thereby obtaining a granulated product of Comparative Example 3 (water content: 5 wt % or less).

### Example 4

After a kale powder (obtained by pulverizing and powdering kale, median diameter: 30 μm) was charged into a fluidized bed granulator, water of 80 wt % relative to a weight of the kale powder was intermittently sprayed while the kale powder was fluidized by supplying air of 65° C. Then the kale powder was dried by supplying air of 80° C., thereby obtaining a granulated product of Example 4 (water content: 5 wt % or less).

### Example 5

After an ashitaba powder (obtained by pulverizing and powdering ashitaba, median diameter: 30 inn) was charged into a fluidized bed granulator, water of 80 wt % relative to a weight of the ashitaba powder was intermittently sprayed while the ashitaba powder was fluidized by supplying air of 65° C. Then the ashitaba powder was dried by supplying air of 80° C., thereby obtaining a granulated product of Example 5 (water content: 5 wt % or less).

### Comparative Example 4

After the same ashitaba powder as in Example 5 was charged into a fluidized bed granulator, water of 10 wt % relative to a weight of the ashitaba powder was intermittently sprayed while the ashitaba powder was fluidized by supplying air of 80° C. Then, the ashitaba powder was dried by supplying air of 80° C., thereby obtaining a granulated product of Comparative Example 4 (water content: 5 wt % or less).

### Comparative Example 5

After a green tea powder (matcha powder obtained by powdering tencha [steamed green tea], median diameter: 30 μm) was charged into a fluidized bed granulator, water of 30 wt % relative to a weight of the green tea powder was intermittently sprayed while the green tea powder was fluidized by supplying air of 75° C. Then, the green tea powder was dried by supplying air of 120° C., thereby obtaining a granulated product of Comparative Example 5 (water content: 5 wt % or less).

### Example 6

After a raw material obtained by mixing a powder of young sweet potato leaves (obtained by pulverizing and powdering sweet potato leaves, median diameter: 30 μm) with the green tea powder used in Comparative Example 6 such that an amount of each of them was 50 wt % was charged into a fluidized bed granulator, water of 80 wt % relative to a total weight of the raw material was intermittently sprayed while the raw material was fluidized by supplying air of 65° C. Then the raw material was dried by supplying air of 120° C., thereby obtaining a granulated product of Example 6 (water content: 5 wt % or less).

### Comparative Example 6

After a raw material obtained by mixing the powder of young sweet potato leaves used in Example 6 and the green tea powder used in Comparative Example 6 such that an amount of each of them was 50 wt % was charged into a fluidized bed granulator, water of 20 wt % relative to a total weight of the raw material was intermittently sprayed while the raw material was fluidized by supplying air of 80° C. Then, the raw material was dried by supplying air of 80° C., thereby obtaining a granulated product of Comparative Example 6 (water content: 5 wt % or less).

Measurement of Specific Gravity and Particle Size Distribution

Specific gravities and particle size distributions of Examples and Comparative Examples were measured by the same methods as in Test 1. The results are shown in Table 9.

Evaluation of Dispersibility and Smoothness

The dispersibility and smoothness (feeling of going down a throat) were evaluated by the same methods as in Test 1. The results are shown in Table 9.

TABLE 9

| | | | Comparative | Exam- | Exam- | Comparative | Comparative | Exam- | Comparative |
|---|---|---|---|---|---|---|---|---|---|
| | | Example 3 | Example 3 | ple 4 | ple 5 | Example 4 | Example 5 | ple 6 | Example 6 |
| Raw | Powder of young | 80.0 | 80.0 | | | | | | |
| Material | barley leaves | | | | | | | | |
| | Xylooligo- | 5.0 | 5.0 | | | | | | |
| | saccharide, | | | | | | | | |
| | Lactose | 15.0 | 15.0 | | | | | | |
| | Kale powder | | | 100.0 | | | | | |
| | Ashitaba powder | | | | 100.0 | 100.0 | | | |
| | Green tea powder | | | | | | 100.0 | 50.0 | 50.0 |
| | Powder of young | | | | | | | 50.0 | 50.0 |
| | sweet potato leaves | | | | | | | | |
| | Total | 100.0 | 100.0 | 100.0 | 100.0 | 100.0 | 100.0 | 100.0 | 100.0 |
| Specific gravity (g/cm³) | | 0.275 | 0.305 | 0.290 | 0.280 | 0.302 | 0.285 | 0.280 | 0.302 |
| Particle | 500 μm- | 4.0 | 3.0 | 0.0 | 0.5 | 1.0 | 0.0 | 1.0 | 0.0 |
| size | 300 μm-500 μm | 16.5 | 7.0 | 1.0 | 10.5 | 1.0 | 0.0 | 3.0 | 1.0 |
| distribution | 150 μm-300 μm | 26.0 | 11.2 | 15.5 | 14.0 | 10.0 | 2.0 | 21.0 | 9.0 |
| | 106 μm-150 μm | 45.5 | 33.8 | 30.5 | 35.0 | 38.0 | 11.0 | 45.0 | 45.0 |
| | −106 μm | 8.0 | 45.0 | 53.0 | 40.0 | 50.0 | 87.0 | 30.0 | 45.0 |
| | Total | 100.0 | 100.0 | 100.0 | 100.0 | 100.0 | 100.0 | 100.0 | 100.0 |
| Dispers- | Affinity for water | A | B | A | A | A | B | A | A |
| ibility | Powder floating | Absence | Presence | Absence | Absence | Presence | Presence | Absence | Presence |
| | Dispersion stability | A | A | A | A | A | A | A | A |
| | Comprehensive | A | B | A | A | B | B | A | B |
| | evaluation | | | | | | | | |

| | | | | | | | | |
|---|---|---|---|---|---|---|---|---|
| Feeling of going down a throat | A | A | A | A | A | B | A | A |

Summary of Results

Granulated products containing the powder of young barley leaves, the kale powder, the ashitaba powder, or the powder of young sweet potato leaves and having a specific gravity of less than 0.300 g/cm³ (Examples 3 to 6) were excellent in the dispersibility and feeling of going down a throat. On the other hand, granulated products having a specific gravity of 0.300 g/cm³ or more were excellent in feeling of going down a throat but poor in dispersibility even if the granulated products contain the powder of young barley leaves, the ashitaba powder, or the powder of young sweet potato leaves (Comparative Examples 3, 4, and 6). In addition, a granulated product made of the green tea powder was poor in the dispersibility and feeling of going down a throat even if the granulated product had a specific gravity of less than 0.300 g/cm³ (Comparative Example 5).

—Test 3—

### Production of Granulated Product Containing Dry Powder of Green Leaves

A granulated product containing a dry powder of green leaves of a aojiru material was produced by the method described below.

### Example 7

After a raw material obtained by mixing 60 wt % of a powder of squeezed juice of mulberry leaves (squeezed juice powder obtained by adding dextrin to the squeezed juice of mulberry leaves and performing drying and powdering by spray drying, a ratio of squeezed juice of mulberry leaves to dextrin was 1:1) and 40 wt % of reduced maltose was charged into a fluidized bed granulator, water of 20 wt % relative to a total weight of the raw material was intermittently sprayed while the raw material was fluidized by supplying air of 70° C. Then the raw material was dried by supplying air of 100° C., thereby obtaining a granulated product of Example 7 (water content: 5 wt % or less).

### Comparative Example 7

After a raw material obtained by mixing 60 wt % of the powder of squeezed juice of mulberry leaves used in Example 7 and 40 wt % of reduced maltose was charged into a fluidized bed granulator, water of 20 wt % relative to a total weight of the raw material was intermittently sprayed while the raw material was fluidized by supplying air of 80° C. Then the raw material was dried by supplying air of 80° C., thereby obtaining a granulated product of Comparative Example 7 (water content: 5 wt % or less).

### Example 8

After a raw material obtained by mixing 60 wt % of a powder of squeezed juice of young barley leaves (squeezed juice powder obtained by adding dextrin to the squeezed juice of young barley leaves and performing drying and powdering by spray drying, a ratio of squeezed juice of young barley leaves to dextrin was 1:1) and 40 wt % of reduced maltose was charged into a fluidized bed granulator, water of 20 wt % relative to a total weight of the raw material was intermittently sprayed while the raw material was fluidized by supplying air of 70° C., and then the raw material was dried by supplying air of 100° C., thereby obtaining a granulated product of Example 8 (water content: 5 wt % or less).

### Example 9

After a raw material obtained by mixing 60 wt % of a powder of squeezed juice of ashitaba (obtained by adding dextrin to the squeezed juice of ashitaba and performing drying and powdering by spray drying, a ratio of squeezed juice of ashitaba to dextrin was 1:1) and 40 wt % of reduced maltose was charged into a fluidized bed granulator, water of 20 wt % relative to a total weight of the raw material was intermittently sprayed while the raw material was fluidized by supplying air of 70° C., and then the raw material was dried by supplying air of 100° C., thereby obtaining a granulated product of Example 9 (water content: 5 wt % or less).

Measurement of Specific Gravity and Particle Size Distribution

Specific gravities and particle size distributions of Examples and Comparative Examples were measured by the same methods as in Test 1. The results are shown in Table 10.

Evaluation of Dispersibility and Smoothness

The dispersibility and smoothness (feeling of going down a throat) were evaluated by the same methods as in Test 1. The results are shown in Table 10.

TABLE 10

| | | | Comparative | | |
|---|---|---|---|---|---|
| | | Example 7 | Example 7 | Example 8 | Example 9 |
| Raw | powder of squeezed juice of | 60.0 | 60.0 | | |
| Material | mulberry leaves | | | | |
| | powder of squeezed juice of | | | 60.0 | |
| | young barley leaves | | | | |
| | powder of squeezed juice of | | | | 60.0 |
| | ashitaba | | | | |
| | reduced maltose | 40.0 | 40.0 | 40.0 | 40.0 |
| | Total | 100.0 | 100.0 | 100.0 | 100.0 |
| Specific gravity (g/cm³) | | 0.295 | 0.320 | 0.295 | 0.290 |
| Particle size | 500 μm- | 5.0 | 0.0 | 0.0 | 9.0 |
| distribution | 300 μm-500 μm | 8.0 | 0.0 | 6.0 | 17.0 |
| | 150 μm-300 μm | 22.0 | 12.0 | 25.0 | 34.0 |
| | 106 μm-150 μm | 40.0 | 33.0 | 41.0 | 25.0 |
| | -106 μm | 25.0 | 55.0 | 28.0 | 15.0 |
| | Total | 100.0 | 100.0 | 100.0 | 100.0 |
| Dispersibility | Affinity for water | A | A | A | A |
| | Powder floating | Absence | Presence | Absence | Absence |
| | Dispersion stability | A | A | A | A |
| | Comprehensive evaluation | A | B | A | A |

| | | | | |
|---|---|---|---|---|
| Feeling of going down a throat | A | A | A | A |

Summary of Results

Granulated products containing the powder of squeezed juice of mulberry leaves, the powder of squeezed juice of young barley leaves, or the powder of squeezed juice of ashitaba and having a specific gravity of less than 0.300 g/cm³ (Examples 7 to 9) were excellent in the dispersibility and feeling of going down a throat. On the other hand, a granulated product containing the powder of squeezed juice of mulberry leaves and having a specific gravity of 0.300 g/cm³ or more was excellent in feeling of going down a throat but poor in dispersibility (Comparative Example 7).

—Test 5—

### Production of Granulated Product Containing Dry Powder of Green Leaves

A granulated product containing a dry powder of green leaves of a aojiru material was produced by the method described below.

### Example 10

After a powder of young barley leaves (median diameter: 18 μm) was charged into a fluidized bed granulator, water of 80 wt % relative to a weight of the powder of young barley leaves was intermittently sprayed while the powder of young barley leaves was fluidized by supplying air of 60° C. Then the powder of young barley leaves was dried by supplying air of 100° C., thereby obtaining a granulated product of Example 10 (water content: 5 wt % or less). The granulated product of Example 10 had a specific gravity of 0.160 g/cm³ and a particle size distribution of 60% or more with a particle diameter of 150 μm or less. The granulated product of Example 10 was excellent in the dispersibility and feeling of going down a throat.

—Test 6—

### [Production of Granulated Product Containing Dry Powder of Green Leaves]

A granulated product containing a dry powder of green leaves of a aojiru material was produced by the method described below.

### Example 11

After a powder of mulberry leaves (obtained by pulverizing and powdering mulberry leaves, median diameter: 30 μm) was charged into a fluidized bed granulator, water of 80 wt % relative to a weight of the powder of mulberry leaves was intermittently sprayed while the powder of mulberry leaves was fluidized by supplying air of 55° C. Then, the powder of mulberry leaves was dried by supplying air of 120° C., thereby obtaining a granulated product of Example 11 (water content: 5 wt % or less).

### Example 12

After a mugwort powder (obtained by pulverizing and powdering mugwort, median diameter: 30 μm) was charged into a fluidized bed granulator, water of 80 wt % relative to a weight of the mugwort powder was intermittently sprayed while the mugwort powder was fluidized by supplying air of 55° C. Then, the mugwort powder was dried by supplying air of 120° C., thereby obtaining a granulated product of Example 12 (water content: 5 wt % or less).

### Example 13

After a Peucedanum japonicum powder (obtained by pulverizing and powdering Peucedanum japonicum, median diameter: 30 μm) was charged into a fluidized bed granulator, water of 80 wt % relative to a weight of the Peucedanum japonicum powder was intermittently sprayed while the Peucedanum japonicum powder was fluidized by supplying air of 55° C. Then, the Peucedanum japonicum powder was dried by supplying air of 120° C., thereby obtaining a granulated product of Example 13 (water content: 5 wt % or less).

### Example 14

After a kuma bamboo grass powder (obtained by pulverizing and powdering the kuma bamboo grass powder, median diameter: 30 μm) was charged into a fluidized bed granulator, water of 80 wt % relative to a weight of the kuma bamboo grass powder was intermittently sprayed while the kuma bamboo grass powder was fluidized by supplying air of 55° C. Then, the kuma bamboo grass powder was dried by supplying air of 120° C., thereby obtaining a granulated product of Example 14 (water content: 5 wt % or less).

The granulated products of Examples 11 to 14 had a specific gravity of 0.280 g/cm³ or less and a particle size distribution of 60% or more with a particle diameter of 150 μm or less. All of these granulated products were excellent in the dispersibility and feeling of going down a throat.

### INDUSTRIAL APPLICABILITY

The granulated product according to the present invention is a granulated product which contains a dry powder of green leaves of at least one kind selected from grains, kale, sweet potatoes, mulberry trees, ashitaba, mugwort, Peucedanum japonicum, and kuma bamboo grass, and is excellent in dispersibility and smoothness, and can be used as a food or drink such as a powder beverage. Thus the granulated product has high industrial utility.

Although the present invention has been described in detail with reference to specific embodiments, it is obvious to those skilled in the art that various changes and modifications can be made without departing from the spirit and scope of the present invention. The present application is based on Japanese Patent Application No. 2021-115226 filed on Jul. 12, 2021 and Japanese Patent Application No. 2022-064382 filed on Apr. 8, 2022, the contents of which are incorporated herein by reference.

1. A granulated product comprising a dry powder of green leaves of at least one kind selected from grains, kale, sweet potatoes, mulberry trees, ashitaba, mugwort, Peucedanum japonicum, and kuma bamboo grass, wherein the granulated product has a specific gravity of less than 0.300 g/cm³.

2. The granulated product according to claim 1, wherein the green leaves are green leaves of grains.

3. The granulated product according to claim 1, wherein a particle size distribution with a particle diameter of 500 μm or more is 10% or less in the granulated product.

4. The granulated product according to claim 2, wherein a particle size distribution with a particle diameter of 500 μm or more is 10% or less in the granulated product.

5. A method for producing a granulated product containing a dry powder of green leaves of at least one kind selected from grains, kale, sweet potatoes, mulberry trees, ashitaba, mugwort, Peucedanum japonicum, and kuma bamboo grass, the method comprising:
obtaining a granulated product by charging a raw material containing the dry powder of the green leaves into a fluidized bed granulator, fluidizing the raw material by supplying air, spraying water, and then drying the raw material,
wherein the granulated product has a specific gravity of less than 0.300 g/cm³.
